(19) United States
(12) Patent Application Publication
(10) Pub. No.: US 2026/0249401 A1
(43) Pub. Date: Aug. 27, 2026

(54) WIRE MADE OF AN ALUMINUM-BASED ALLOY FOR ADDITIVE MANUFACTURING, USE THEREOF AND PROCESS FOR PRODUCING AN OBJECT BY ADDITIVE MANUFACTURING

(71) Applicant: LKR LEICHTMETALLKOMPETENZZENTRUM RANSHOFEN GMBH, Braunau am Inn - Ranshofen (AT)

(72) Inventor: Thomas KLEIN, Braunau am Inn (AT)

(73) Assignee: LKR LEICHTMETALLKOMPETENZZENTRUM RANSHOFEN GMBH, Braunau am Inn - Ranshofen (AT)

(21) Appl. No.: 19/475,995

(22) PCT Filed: Jan. 11, 2023
(86) PCT No.: PCT/AT2023/060004

§ 371 Date: Oct. 16, 2025

(30) Foreign Application Priority Data
Jan. 21, 2022 (AT) A 50025/2022

(51) Int. Cl. B23K 35/28; B23K 35/02; B23K 103/10; B33Y 10/00; B33Y 40/20; B33Y 70/00; C22C 21/06

(52) U.S. Cl. CPC B23K 35/288; B23K 35/0261; B33Y 10/00; B33Y 40/20; B33Y 70/00; C22C 21/06; B23K 2103/10

(57) ABSTRACT

The invention relates to a wire made of an aluminum-based alloy for additive manufacturing. In order to be able to create objects with good mechanical properties from a corresponding wire, the wire has (in % by wt.): 2.0% to 6.0% zinc, 3.5% to 7.0% magnesium, optionally up to 1.5% manganese, up to 1.75% copper, up to 1.5% sliver, optionally up to 0.45% zirconium, remainder aluminum and production-related impurities. The invention further relates to a use of a wire of this type and to a process for producing an object by additive manufacturing.

The invention relates to a wire made of an aluminum-based alloy for additive manufacturing.

The invention further relates to the use of a wire of this type.

Finally, the invention relates to a process for producing an object by additive manufacturing.

In the more recent past, the additive manufacturing of objects has made greater inroads into production processes and is beginning to, or has already, become established as a vital process technology for the production of certain objects. This applies not only to the field of plastics, but also to objects made of a metal or an alloy which are normally processed, by casting, into a semi-finished product, which is then further processed to the final dimensions, in particular by forming, material-removing, or other shaping processes. It is also possible to directly produce metals and alloys in a near-net-shape manner, after which other additional process steps are usually provided, however, for the purpose of obtaining a final shape, for example, milling, lathing or roughing treatments.

Particularly for metals and alloys, additive manufacturing also offers many advantages in terms of an effective and efficient production of complex geometries. This also applies to aluminum alloys which can be processed into objects to a large extent in any desired shape by additive manufacturing, for example various automotive and aircraft parts.

When aluminum alloys are processed by additive manufacturing, a fusion welding is normally used, wherein fusion welding equipment that is typically already on hand is used and an electric arc, plasma, or laser can be used as a heat source. The aluminum alloy is thereby supplied in the form of a wire and, by a point-melting of the wire, melted and allowed to solidify while the object that is to be created is formed.

For the additive manufacturing of objects from aluminum alloys, alloy wires from the 2xxx, 4xxx, 5xxx, and more rarely, the 6xxx series, can be acquired. Corresponding alloys can be processed well the form of a wire in the fusion welding process, but the mechanical properties are insufficient or unsatisfactory for many applications. Generally speaking, each of the individual series provides special advantages, but also problems. For example, alloys from the 6xxx series normally exhibit good mechanical properties, but are at best very difficult to process. Alloys from the 5xxx series can, for example, be strengthened very well by forming, which, in combination with additive processing methods, leads to a reduction in the feasible geometric complexity, however.

Attempts have already been made to develop alloys which have a balanced property profile and are better suited to additive manufacturing. These include in particular alloys of the type Al—Zn—Mg—Cu, which have been studied in this context (B. J. Morais et al., Materials 2020, 13, 1610; D. Klein et al., Additive Manufacturing 37, 2021, 101663).

Corresponding wires made of 7xxx alloys can indeed be processed into complex geometries by additive manufacturing, but the workability is difficult, since the corresponding alloys tend very strongly to form hot cracks during fusion welding. For a production of automotive and aircraft parts or the like on an industrial scale, which normally must satisfy the strictest requirements in terms of failure, this is not acceptable. In some cases, it is also not possible to achieve the strength required for automotive and aircraft parts.

This is addressed by the invention. The object of the invention is to specify a wire of the type named at the outset which is further developed such that the wire allows the creation of improved objects by additive manufacturing with a wire made of the aluminum alloy, in particular with regard to a reduction of hot cracks with a simultaneously high strength.

A further object is to specify a use of a wire of this type.

Another additional object of the invention is to further develop a process of the type named at the outset such that objects with improved quality can be created from a wire made of an aluminum alloy by additive manufacturing in the fusion welding process.

The object according to the invention is attained by a wire made of an aluminum-based alloy for additive manufacturing, comprising (in percent by weight, hereinafter abbreviated as % by wt.):
2.0% to 6.0% zinc
3.5% to 7.0% magnesium
optionally up to 1.5% manganese
up to 1.75% copper
up to 1.5% sliver
optionally up to 0.45% zirconium
remainder aluminum and production-related impurities.

A wire of this type has, in particular, the advantage of a good workability with the possibility of being able to set mechanical properties at a desired level. Particularly in the case of the typically provided processing of the wire by melting, specifically in a fusion welding process, for example using common fusion welding equipment, the undesirable hot cracking tendency can be prevented or at least inhibited to a large extent. By tailoring the alloy composition with relatively high magnesium contents and, in particular, the addition of silver, it is possible to influence, in a positive decreasing manner, the hot cracking tendency during the melting of the alloy and the subsequent solidification on the one hand and, on the other hand, good mechanical parameters can be obtained following a heat treatment process. In this context, it is presumed that sliver influences the formation of strength-increasing phases by modifying the nucleation mechanism. Through a strong interaction of silver with vacancies, a refining of the microstructure is thereby effected, which in turn has a beneficial effect for a high strength. Immediately following a wire-based additive processing, very fine microsegregation zones are present in the created material, which can be attributed to magnesium, zinc, copper, and silver. During a subsequent heat treatment, said microsegregation zones can be dissolved, and finely distributed particles can be precipitated therefrom, which contributes to the desired hardness. Thus, with the envisaged composition of the alloy, an alloy concept is provided which, for the desired additive manufacturing by melting a wire of an aluminum-based alloy, enables the production of objects with good mechanical properties and with a reduced hot cracking tendency.

In principle, zinc has a beneficial effect for a high strength, and is therefore preferably provided at a minimum content. An upper threshold value results from the workability of the aluminum-based alloy. Based on these aspects, a content of zinc is advantageously 2.5% to 5.5%, preferably 2.75% to 4.5%, in particular 3.0% to 4.0%, for example 3.25% to 4.25%.

Similar considerations apply to magnesium, which, in a preferred embodiment, can be present at a content of 3.75% to 6.0%, preferably 4.0% to 5.5%, in particular 4.15% to 5.0%. As mentioned, higher magnesium contents in particular contribute to the reduction of a hot cracking tendency.

Manganese affects a low adhesion tendency, which is beneficial for a production process up to the finished wire and ensures a coalescence of ductility-reducing phases, and is therefore advantageously provided at a content of 0.1% to 1.0%, particularly preferably 0.25% to 0.75%.

In a preferred embodiment, copper can be provided at a content of 0.05% to 0.75%, preferably 0.1% to 0.5%, in particular 0.15% to 0.45%.

Silver is necessarily provided in a wire made of a corresponding aluminum-based alloy. Advantageously, the content of silver is 0.03% to 1.0%, preferably 0.05% to 0.85%, in particular 0.075% to 0.50%, for example 0.10% to 0.30%. As previously mentioned, the presence of sliver in the tailored alloy concept is especially helpful in order to be able to achieve high strengths by heat treatment. Zirconium is conducive to the formation of precipitates, and thus to facilitating a hardening process and a fine solidification structure. In preferred embodiments, zirconium can be provided at contents of 0.03% to 0.5%, preferably 0.05% to 0.3%, in particular 0.075% to 0.15%.

The other object of the invention is attained if a wire according to the invention is used to produce an object by additive manufacturing. As a result, the explained advantages fully come to fruition.

The other additional object of the invention is attained if, in a process of the type named at the outset, the following steps are provided:
a) creating a raw object by additive manufacturing, wherein a wire according to the invention is processed for the purpose of creating the raw object;
b) heat treating the raw object in order to obtain the object.

In a corresponding process, an object is created from an aluminum-based alloy that is present in the form of a wire. In said process, the wire is melted. Common fusion welding equipment can be used in this case. The wire used does not require any heat treatment on its own; according to the invention, however, the raw object created from the wire by fusion welding shall be heat treated in order to achieve an optimal property profile. Through the setting, explained above, of the composition of the alloy for the wire, a hot cracking tendency in connection with the fusion welding process or additive manufacturing can be minimized. The mechanical properties can be set by a suitable heat treatment after the step of the additive manufacturing of the raw object from the wire.

The heat treating advantageously comprises a solution annealing and an artificial aging. In this context, artificial aging shall be understood such that the artificial aging can also be composed of individual sub-steps which, when considered in combination, define the artificial aging as a whole.

The solution annealing can occur in particular at a temperature of 430° C. to 500° C. A particularly optimized temperature range is approximately 455° C. to 480° C.

A span of time for the solution annealing depends on the mass of the object being treated. It is expedient if the raw object from which the final object is created by the heat treatment is held at the solution annealing temperature of, for example, 470° C. for up to 60 minutes during the solution annealing.

After the solution annealing, the raw object treated in such a manner is quenched. For the quenching, common quenching media, in particular water, as well as oils or compressed air can be used.

After the solution annealing treatment with the envisaged holding at a temperature and subsequent quenching, an artificial aging occurs. It has proven to be an advantage if the artificial aging occurs in multiple stages, and therefore in multiple sub-steps. Taken together, the sub-steps constitute the artificial aging. The artificial aging can thereby be carried out at a first temperature for a first length of time and then at a second temperature for a second length of time, wherein the second temperature is higher than the first temperature and/or the second length of time is longer than the first length of time. Between the heat treatment steps, a cooling in air can occur; however, this is not imperative. In a corresponding heat treatment, and thus also with the preceding step of the solution annealing, microsegregation zones are dissolved, whereas dispersoids persist in an unaltered manner. The latter is advantageous since the dispersoids which cannot be eliminated by the solution annealing counteract an undesirable grain growth during the solution annealing itself and, subsequently, during the artificial aging. On the other hand, the microsegregation zones dissolve and, during the subsequent artificial aging, form fine precipitates which increase the hardness of the material.

Additional features, advantages, and effects of the invention follow from the exemplary embodiment described below. In the drawings which are thereby referenced:

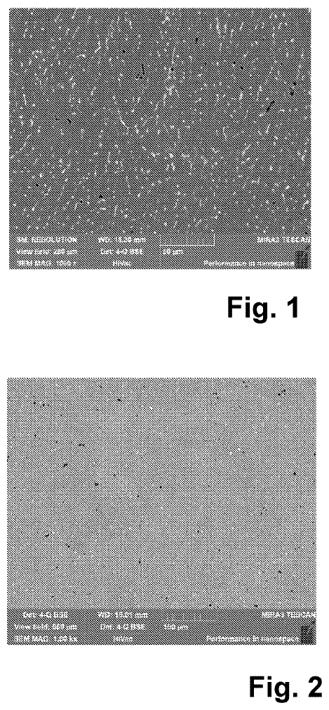

FIG. 1 shows a backscatter electron microscopic image of a region of a raw object;

FIG. 2 shows backscatter electron microscopic image of a heat-treated raw object or object;

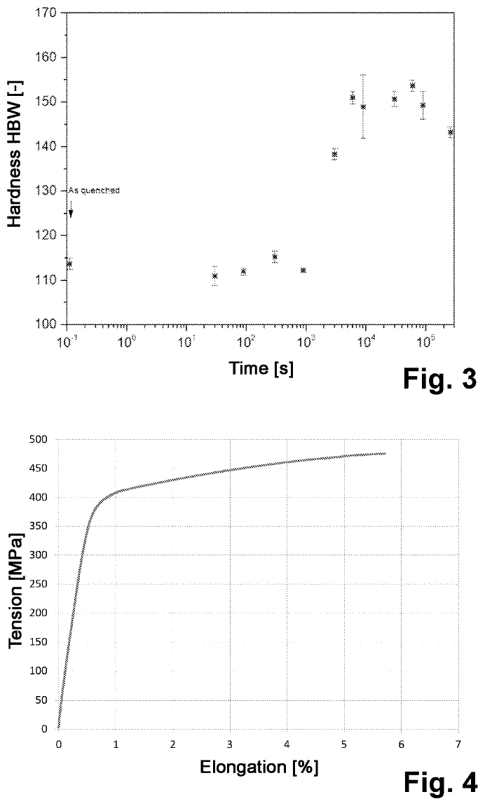

FIG. 3 shows a graph for the hardness as a function of an artificial aging time;

FIG. 4 shows a graph for tensile tests.

A wire made of an aluminum-based alloy having the composition stated in Table 1, a raw object was created by additive manufacturing. For this purpose, the wire was melted using common fusion welding equipment, and the raw object was created by automated scanning.

TABLE 1
Wire composition

| Element | Al | Zn | Mg | Mn | Cu | Ag | Zr |
|---|---|---|---|---|---|---|---|
| % by wt. | Remainder | 3.5 | 5.5 | 0.5 | 0.3 | 0.2 | 0.1 |

In FIG. 1, a backscatter electron microscopic (BEM) image of the raw object created from the wire is shown. Neither the raw object, nor the wire used was heat treated. It can be seen that microsegregations are present which result from the fusion welding process or the melting of the wire and the subsequent solidification. Dispersoids are also visible.

A raw object that was produced as described above was then subjected to a heat treatment. The heat treatment was composed of a solution annealing at 470° C. for 30 minutes. The solution-annealed object was then quenched in water. An artificial aging then took place at 100° C. for three hours, followed by a cooling in air. The object was then further aged at 175° C. for nine hours.

FIG. 2 shows a BEM image of the object heat-treated as described above. It can be seen that the microsegregation zones are no longer present. The corresponding microsegregations were dissolved during the solution annealing and subsequently form the basis for the precipitation of fine particles and thus a hardening. This can be seen in FIG. 3, according to which the hardness can be considerably increased by the final artificial aging steps.

In addition, a correspondingly created object, that is, the object created from the raw object by heat treatment (solution annealing and artificial aging), also exhibits a good tensile strength, as can be seen in FIG. 4. The corresponding material parameters are summarized in Table 2 below.

TABLE 2
Material parameters of a heat-treated raw object or object

| | Heat-treated raw object (=object) |
|---|---|
| Yield strength [MPa] | 394.1 ± 10.3 |
| Fracture toughness [MPa] | 468.9 ± 16.1 |
| Elongation at break [%] | 5.1 ± 2.7 |

In addition to the desirable good mechanical properties, correspondingly produced objects also have the advantage that a hot cracking tendency during the creation of the objects is prevented or at least reduced. By increasing the magnesium content compared to conventional 7xxx alloys, a reduction of the hot cracking tendency results. Through the combinatorial influence of silver, which results in a refining of the precipitate structure due to a strong interaction with vacancies, it is in turn possible to markedly increase the strength. This results in a wire with an alloy composition which is tailored to a robust workability and provides a high level for a subsequent increase in strength of an object produced by additive manufacturing.

Although a wire according to the invention is primarily used in additive manufacturing, it can also be provided that the wire is used in combination welding, though the advantages explained in the foregoing come to particular fruition in the additive manufacturing of a raw object and the subsequent heat treatment thereof for the production of a final object.

1. A wire made of an aluminum-based alloy for additive manufacturing, comprising (in % by wt.):
2.0% to 4.0% zinc;
3.5% to 5.5% magnesium;
0.1% up to 1.5% manganese;
up to 1.75% copper;
up to 1.5% silver;
optionally up to 0.45% zirconium; and
remainder aluminum and production-related impurities.

2. The wire according to claim 1, comprising:
2.5% to 4.0%, preferably 2.75% to 4.0%, in particular 3.0% to 4.0%, for example 3.25% to 4.0%, zinc.

3. The wire according to claim 1, comprising:
3.75% to 5.5%, preferably 4.0% to 5.5%, in particular 4.15% to 5.0%, magnesium.

4. The wire according to claim 1, comprising:
0.1% to 1.0%, preferably 0.25% to 0.75%, manganese.

5. The wire according to claim 1, comprising:
0.05% to 0.75%, preferably 0.1% to 0.5%, in particular 0.15% to 0.45%, copper.

6. The wire according to claim 1, comprising:
0.03% to 1.0%, preferably 0.05% to 0.85%, in particular 0.075% to 0.50%, for example 0.10% to 0.30%, silver.

7. The wire according to claim 1, comprising:
0.03% to 0.45%, preferably 0.05% to 0.3%, in particular 0.075% to 0.15%, zirconium.

8. A use of a wire according to claim 1 for producing an object by additive manufacturing.

9. A process for producing an object by additive manufacturing, comprising the following:
a) creating a raw object by additive manufacturing, wherein a wire according to claim 1 is processed for the purpose of creating the raw object;
b) heat treating the raw object in order to obtain the object.

10. The process according to claim 9, wherein step b) the heat treating comprises a solution annealing and an artificial aging.

11. The process according to claim 10, wherein the solution annealing occurs at a temperature of 430° C. to 500° C.

12. The process according to claim 11, wherein the solution annealing takes place at the temperature for a span of time of up to 60 minutes.

13. The process according to claim 10, wherein the artificial aging is carried out in multiple stages.

14. The process according to claim 13, wherein the artificial aging is carried out at a first temperature for a first length of time and then at a second temperature for a second length of time, wherein the second temperature is higher than the first temperature and/or the second length of time is longer than the first length of time.
